(19) United States
(12) Patent Application Publication
(10) Pub. No.: US 2011/0261941 A1
(43) Pub. Date: Oct. 27, 2011

(54) MONITORING INMATE CALLS USING SPEECH RECOGNITION

(76) Inventors: Jay Walters, Hallsville, TX (US); Randy L. Reeves, Gladewater, TX (US); William L. Pope, Longview, TX (US)

(21) Appl. No.: 12/768,439

(22) Filed: Apr. 27, 2010

(51) Int. Cl. H04M 3/00; G10L 15/26; G10L 15/04

(52) U.S. Cl. 379/188; 704/251; 704/E15.043

(57) ABSTRACT

A system and method for monitoring telephone activity and conversation content in a correctional facility comprises providing a communicative connection between a caller and a recipient, alerting at least one of the caller and the recipient that the communications may be recorded, delivering the conversation between the caller and the recipient over the communicative connection and storing the conversation into a call record memory. After the communicative connection has been terminated, speech recognition software is executed to identify a plurality of conversation words within the call record memory. By comparing the conversation words with a database of trigger words, a determination can be made as to whether the conversation is of interest to the correctional facility. Based on that comparison step, a detection response is executed.

### BACKGROUND

The present invention generally relates to telecommunications monitoring and, more specifically, to a system and method for monitoring phone calls to and from an inmate within a correctional facility through the use of speech recognition software.

There exists a need to control and monitor access to telephone lines in a correctional facility, such as a prison or jail. By and large, such control and monitoring systems are implemented for security considerations. One such security concern is an inmate's attempt to plot, conspire and/or scheme with individuals outside of the correctional facility to coordinate criminal or unlawful activity. Naturally, the correctional facility may choose to have an individual listen to and monitor each phone call originating from and delivered to the correctional facility. However, such a measure would be logistically difficult and require a considerable amount of resources in both time and money. Similarly, the correctional facility may be interested in other topics the inmates may discuss, such as the details of a certain event or person.

Additionally, like all technologies, the way people send and receive phone calls is continuing to evolve. More and more companies and individuals are utilizing voice over internet protocol (VoIP) services. VoIP is a general term for a range of communication transmission technologies designed to deliver voice and other forms of communication over IP networks, such as the internet or other packet-switched networks, as opposed to the public switched telephone network (PSTN). Because of the bandwidth efficiency and low costs that VoIP technology can provide, businesses and other institutions (such as correctional facilities) are beginning to utilize VoIP services in place of their traditional copper-wire telephone systems.

There is a need for a system and method for efficiently monitoring inmate communications delivered via VoIP.

### SUMMARY

The present invention provides an improved inmate call monitoring system and method. The claims, and only the claims, define the invention.

The principles of the present disclosure provide a system and method for monitoring and controlling inmate telephone calls delivered via VoIP or other means. By using software to identify and review the words spoken during the telephone conversation, the disclosed monitoring and control system can efficiently determine whether the call should be flagged as of potential interest to the correctional facility. When such a determination is made, the call is flagged and the correctional facility may be notified.

In one aspect of the present disclosure, a method for monitoring telephone activity and conversation content in a correctional facility is provided. The method comprises the steps of providing a communicative connection between a caller and a recipient, alerting at least one of the caller and the recipient that the communications may be recorded, delivering the conversation between the caller and the recipient over the communicative connection and storing the conversation into a call record memory. After the communicative connection has been terminated, speech recognition software is executed to identify a plurality of conversation words within the call record memory. By comparing the conversation words with a database of trigger words, a determination can be made as to whether the conversation is of interest to the correctional facility. Based on that comparison step, a detection response is executed.

It is an object of certain embodiments of the present disclosure is to provide an improved inmate call monitoring system and method.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is an illustration of an exemplary system to monitor and control inmate calls in accordance with the principles of the present disclosure.

FIG. 2 is an illustration of another embodiment of a system to monitor and control inmate calls in accordance with the principles of the present disclosure.

FIG. 3 is a flow chart for the post-conversation call flagging determination according to one embodiment of the present disclosure.

FIG. 4 is a flow chart for the post-conversation call flagging determination according to a further embodiment of the present disclosure.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The language used in the claims is to only have its plain and ordinary meaning, except as may be explicitly defined herein. Such plain and ordinary meaning is inclusive of all consistent dictionary definitions from the most recently published Webster's dictionaries and Random House dictionaries.

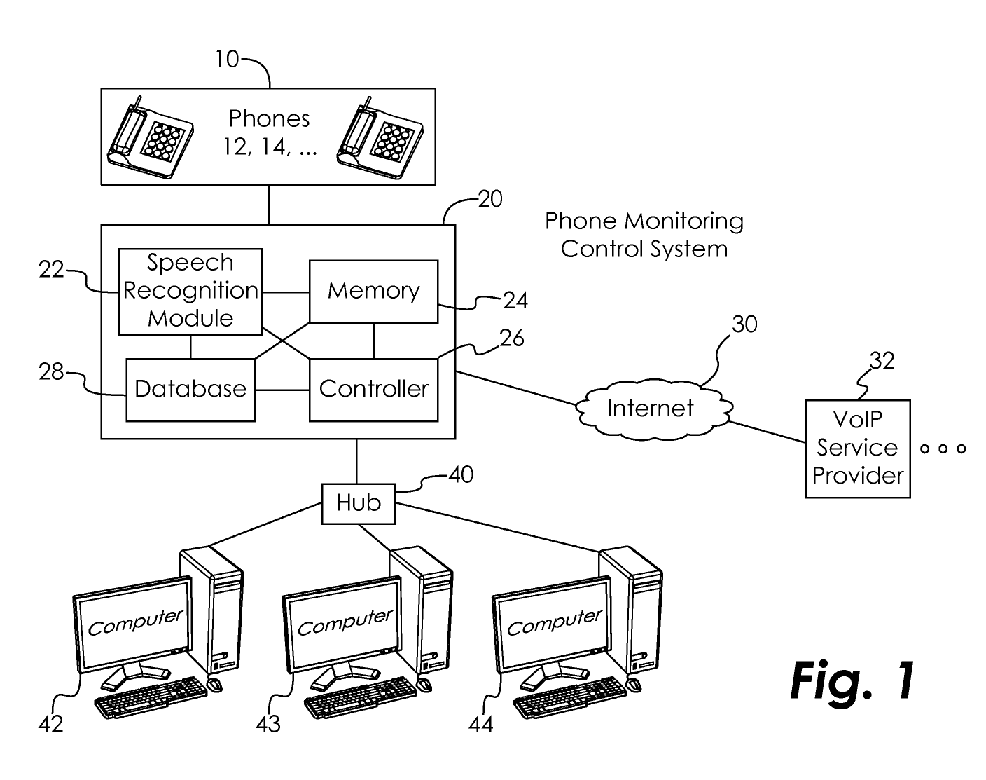

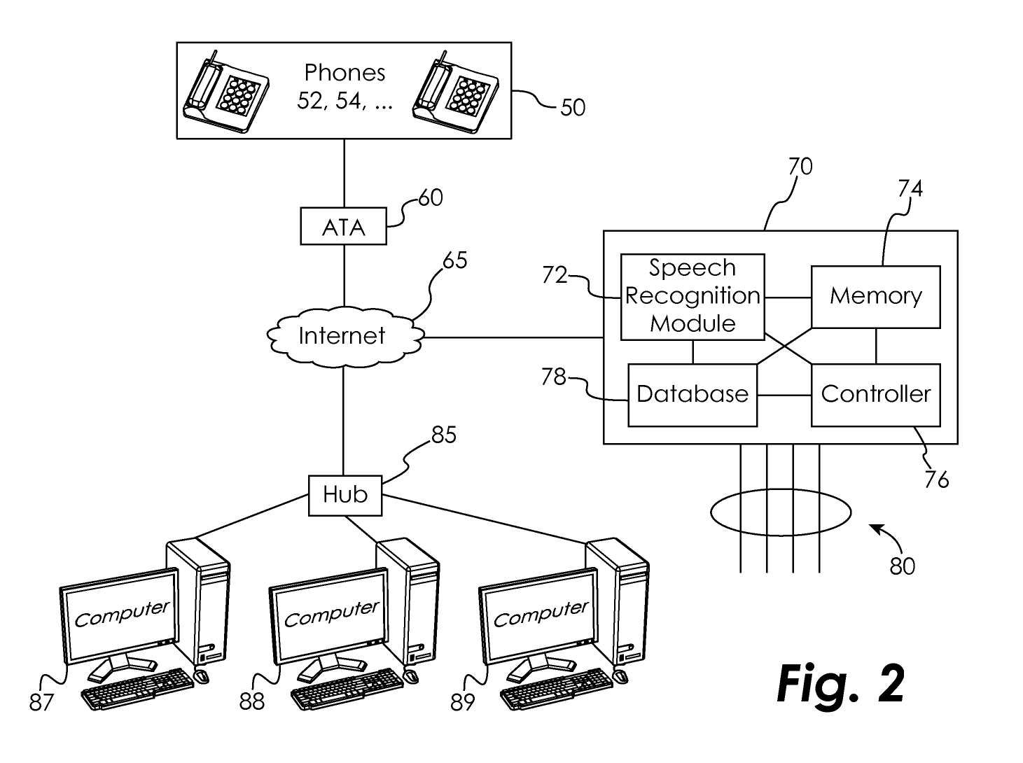

FIG. 1 is an illustrative embodiment of a disclosed system for monitoring and controlling inmate telephone calls originating from a telephone bank 10 within a correctional facility. Telephone bank 10 includes a plurality of individual inmate telephones 12, 14. A phone monitoring and control system 20 is communicatively and operationally connected to telephone bank 10. Monitoring and control system 20 is connected to the internet 30. Monitoring and control system 20 is constructed and arranged to monitor and control the delivery and receipt of communication signals between telephones 12, 14 and a VoIP service provider 32, which is connected to the internet 30. As appreciated by those of skill in the relevant art, VoIP service provider 32 has the capability of delivering the VoIP communications originating from the inmate telephones 12, 14 to either other VoIP devices via the internet or to standard, analog telephone devices via the PSTN. In some embodiments, system 20 may be at the same location as phones 12, 14. In other embodiments, system 20 may be remotely connected to phones 12, 14 by PSTN, the internet (see FIG. 2 embodiment), or other known communication means.

As illustrated, monitoring and control system 20 comprises a speech recognition module 22, a memory 24, a controller 26, and a database 28. Each of these components is communicatively and operatively connected to one another. The speech recognition module 22 comprises computer software designed to identify and spot spoken words. The speech recognition module 22 can either identify words in a real-time fashion, i.e., during the on-going call, or in a post-processing fashion, i.e., communications stored into memory 24. One example of the software utilized by speech recognition module 22 is the Key Word Spotting product available from Natural Speech Communication Ltd having headquarters in Rishon Lezion, Israel.

Memory 24 is constructed and arranged to optionally store the digital voice communications received from and delivered to inmate telephones 12, 14. In some embodiments, memory 24 is a standard memory component, such as, but not limited to, a hard disk drive, RAM, or ROM, or any other known electrical storage device.

Controller 26 is constructed and arranged to dictate and monitor the operations of monitoring and control system 20 and execute an appropriate response if it is determined that a topic of interest has been discussed. Controller 26 controls the recording of the digital voice communications received from and delivered to inmate telephones 12, 14 onto memory 24. Controller 26 may instruct the memory to record an entire phone call, a portion of the phone call, or to act as a memory buffer, recording a predetermined portion of the call before a triggering word is recognized by the speech recognition module 22. The controller 26 may also be operational to terminate the connection between an inmate telephone 12, 14 and an outside phone line. Additionally, the controller may be operational to decide when the speech recognition module 22 is to be executed.

Database 28 stores and maintains the triggering words and phone numbers. The triggering terms are determined by the correctional facility or appropriate entity as the terms common during a conversation discussing criminal or unlawful behavior or any other topic of possible interest, such as, but not limited to, “murder”, “kill”, “rape”, “steal”, and “gun”, as well as names, phone numbers and events in which the correctional facility has an interest. As illustrated, a single database 28 is provided within monitoring and control system 20. In such a situation, the database 28 is constructed and arranged as a global database against which all of the words and numbers spoken during all inmate telephone conversations are compared. In other embodiments, the database 28 may be constructed and arranged as separate databases specific to each individual inmate. In such an arrangement, the individual databases store words and specific names and numbers which would flag the call as being of interest.

Monitoring and control system 20 is also communicatively coupled to a hub 40. Hub 40 is configured to communicatively and operationally connect correction facility computers 42, 43, 44 with monitoring and control system 20. When system 20 flags a call of interest (be it criminal, unlawful, or otherwise), system 20 is constructed and arranged to optionally notify the correctional facility computers 42, 43, 44 via email, audio and/or visual indication. In turn, computers 42, 43, 44 may access memory 24 to listen to the recorded phone calls. In some embodiments, computers 42, 43, 44 may listen to telephone conversations live. The correctional facility computers 42, 43, 44 may also have the capability of updating database 28 with additional names, words or numbers which will flag the phone calls of interest to the correctional facility. While three correctional facility computers are depicted, other embodiments of the present disclosure may comprise fewer or more than three correctional facility computers.

While speech recognition module 22, memory 24, controller 26, and database 28 are depicted as residing within the same location, it is within the scope of the present disclosure that the components of system 20 do not need to be physically proximate. For example, the database 28 may be physically stored remotely from the other components and accessed via the internet. Monitoring and control system 20 and VoIP service provider 32 are connected to the internet 30 through known techniques.

In one embodiment, system 20 is constructed and arranged to create a text log of the communications delivered between inmate telephones 12, 14 and the outside phone lines. The text log may be stored in memory 24 and retrievable by correctional facility computers 42, 43, 44. The text log is searchable to allow correctional facility personnel to keyword search the words and numbers spoken during the communications. In some embodiments, the text log is created and available for keyword searching “real-time” during the communications. In other embodiments, the text log is created after the communications have ceased.

FIG. 2 is a further illustrative embodiment of a disclosed system for monitoring and controlling inmate telephone calls originating from a telephone bank 50 within a correctional facility. Telephone bank 50 includes a plurality of individual inmate telephones 52, 54. As illustrated, the individual telephones 52, 54 of inmate phone bank 50 are connected to an analog telephone adaptor (ATA) 60, which is communicatively connected to the internet 65. ATA 60 converts the speech spoken into inmate telephones 52, 54 from an analog signal into digital format and compresses/translates the signal into internet protocol for transmission over the internet 65. Conversely, the ATA 60 is designed to convert a communication received in digital format into an analog signal to be heard by the inmate using telephones 52, 54.

A monitoring and control system 70 is communicatively and operationally connected to the internet 65. Monitoring and control system 70 is constructed and arranged to receive the VoIP communication from ATA 60 and relay that communication to outside phone lines 80, and vice versa. The telephone communications sent to and received from outside phone lines 80 may be in VoIP or standard, analog format.

Like the monitoring and control system 20 of FIG. 1, monitoring and control system 70 comprises a speech recognition module 72, a memory 74, a controller 76, and a database 78. For the sake of brevity, the components of system 20 and system 70 are functionally equivalent and reference is made to the above discussion as to the purpose and operation of those components. Any difference between the two systems is discussed below.

A hub 85 is configured to communicatively and operationally connect correctional facility computers 87, 88 and 89 with the internet 65. When system 70 flags a phone call of interest, system 70 is constructed and arranged to notify the correctional facility computers 87, 88, 89 through a notification sent via the internet 65. Through that connection to the internet 65, computers 87, 88, 89 can access memory 74 to listen to the recorded phone calls. Similarly, the correctional facility has the capability of updating database 78 with additional names, words or numbers which will flag calls of interest. In a broader sense, the components of the monitoring and control system 70 may be configured remotely by the correctional facility computers 87, 88, 89 by known techniques, including, but not limited to, GUI or CLI-type interfaces.

ATA 60, monitoring and control system 70, and hub 85 are connected to the internet 65 through known techniques. As depicted in FIG. 2, the monitoring and control system 70 may be located separate from the correctional facility.

ATA 60 may be used with the telephones to convert the analog communications into a digital format. In other embodiments, the individual telephones are VoIP devices thereby eliminating the need for an ATA within the system.

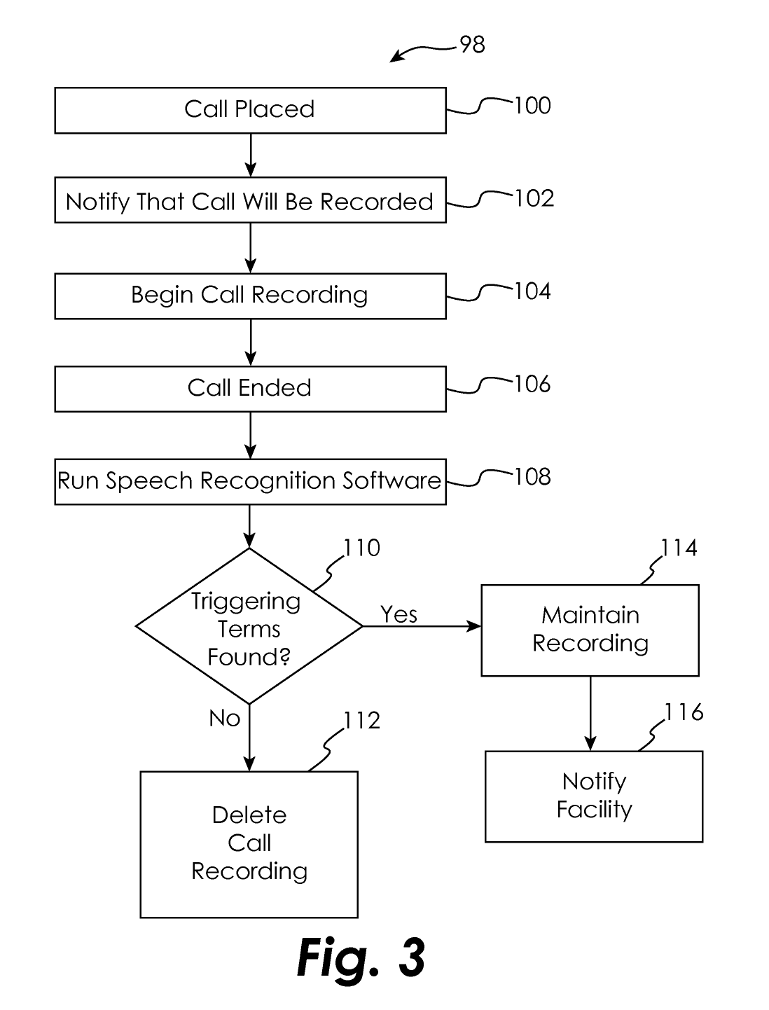

FIG. 3 is a flow chart of an exemplary process 98 for system and method operation for monitoring and controlling inmate telephone calls. The process 98 starts at step 100 when an inmate within the correctional facility places a phone call. Pursuant to some of the embodiments of the present disclosure, the phone calls are delivered and received over the internet via VoIP services. Once the phone call is placed, at least one of caller and recipient are optionally notified that the call will be recorded (step 102). At step 104, the conversation between the inmate caller and the outside recipient is recorded in digital form. In other embodiments, a portion of the conversation is recorded in digital form. In yet further embodiments, portions of the conversation are recorded. At step 106, the telephone call is completed.

According to the illustrated embodiment, the speech recognition software is run at some time after the call is completed (step 108). In other embodiments, the speech recognition software may optionally be executed at some time during the conversation. The speech recognition software identifies the words and numbers spoken during the conversation between the inmate caller and the outside recipient by analyzing the stored digital voice recording. As the words and numbers are identified, they are compared to a database of triggering terms. Again, the triggering terms are determined by the correctional facility or other appropriate entity as the terms common during a conversation discussing criminal or unlawful behavior or any other topic of possible interest, such as, but not limited to, “murder”, “kill”, “rape”, “steal”, “gun”, as well as the names, phone numbers and/or events in which the correctional facility may have an interest.

For the words and numbers spoken, the control and monitoring system will determine if the triggering terms are present within the conversation (decision step 110). If no triggering terms are found during the phone conversation, then the stored call recording may be deleted (step 112). If a triggering term is found, then that is indicative of a conversation of interest to the correctional facility and a detection response may be executed. At step 114, the phone call record is maintained. At step 116, the correctional facility is notified that the call has been flagged.

The detection response may be any desired action the correctional facility determines to take including, but not limited to, alerting the correctional facility personnel that the call has been flagged, archive recording of the conversation, blocking future calls to be placed to that number by the inmate, automatically flagging future calls placed to that number by the inmate, etc. For the call blocking, the monitoring and control system may optionally prohibit a particular inmate from placing a call to the telephone number in which a previous call has been flagged as being of interest. The call blocking may be applied to an inmate for a particular phone number for a specified period of time or permanently.

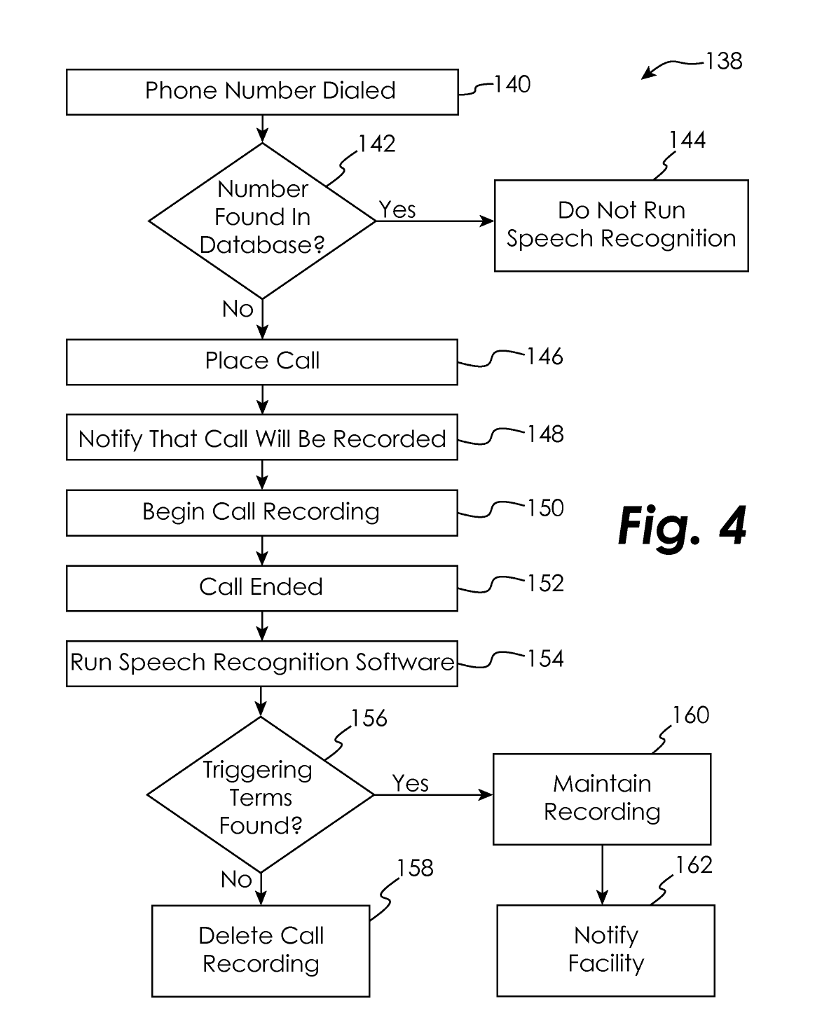

FIG. 4 is a flow chart of yet another exemplary process 138 of system and method operation for monitoring and controlling inmate telephone calls. Due to the attorney-client privilege, the correctional facility may choose to not monitor a telephone conversation between an inmate and his/her attorney. For that reason, the system may include a database which stores the telephone numbers of each inmate's attorney. Accordingly, process 138 starts at step 140 when an inmate within the correctional facility dials the desired phone number to be called. Once the phone number is dialed, the database is searched to determine if that telephone number is associated with the inmate's attorney (decision step 142). If the dialed telephone number is found in the database, then the speech recognition software is not run (step 144). The telephone call is still placed, but the conversation is not recorded or monitored in any way.

If the dialed telephone number is not found in the database, the phone call is placed (step 146) and at least one of the caller and recipient are optionally notified that the call will be recorded (step 148). At step 150, the conversation between the inmate caller and the outside recipient is recorded in digital form. In other embodiments, a portion of the conversation is recorded in digital form. In yet further embodiments, portions of the conversation are recorded. At step 152, the telephone call is completed.

According to the illustrated embodiment, the speech recognition software is run after the call is completed (step 154). In other embodiments, the speech recognition software may optionally be executed at some time during the conversation. The control and monitoring system will determine if triggering terms are present within the conversation (decision step 156). If no triggering terms are found during the phone conversation, then the call recording may be deleted (step 158). If a triggering term is found, then that is indicative of a conversation of interest to the correctional facility and a detection response may be executed. At step 160, the phone call record is maintained. At step 222, the correctional facility is notified that the call has been flagged.

It will be appreciated by those skilled in the art that all of the presently disclosed embodiments may also be implemented for calls originating outside of the correctional facility and placed to an inmate. It will also be appreciated by those skilled in the art that the control and monitoring systems presently disclosed would be equally applicable to phone calls being delivered primarily over a PSTN rather than a VoIP communication system. In some embodiments, the control and monitoring system can tap into the analog phone signal and convert the communications into a digital format, at which point the various components of the control and monitoring system may be implemented as disclosed herein.

As described above, the control and monitoring systems may optionally create a text log of the communications delivered between the inmate telephones and the outside phone lines. That text log may be stored into memory and retrievable by correctional facility computers. Correctional facility personnel would, therefore, have the ability to keyword search the communications. Based on the review of the text log, correctional facility personnel may chose to execute detection response, such as, but not limited to, alerting the correctional facility personnel that the call has been flagged, archive recording of the conversation, blocking future calls to be placed to that number by the inmate, automatically flagging future calls placed to that number by the inmate, etc.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A method for monitoring telephone activity within a correctional facility, the method comprising the steps of:
(a) providing a communicative connection between a caller and a recipient;
(b) delivering a conversation between the caller and the recipient over the communicative connection;
(c) recording at least a portion of the conversation;
(d) storing the recorded conversation into a call record memory;
(e) executing a speech recognition software to identify a plurality of conversation words within the call record memory;
(f) comparing the conversation words with a database of trigger words to determine whether the conversation is of interest to the correctional facility; and
(g) executing a detection response based on the comparing step.

2. The method of claim 1, wherein the detection response comprises notifying the correctional facility that the conversation is of interest.

3. The method of claim 1, wherein the detection response comprises blocking a future communicative connection from being provided between the caller and the recipient.

4. The method of claim 1, wherein the detection response comprises routing the conversation to a live operator when a future communicative connection is provided between the caller and the recipient.

5. The method of claim 1, wherein the caller is inside the correctional facility.

6. The method of claim 1, wherein the conversation between the caller and the recipient is delivered over the communicative connection via voice over internet protocol.

7. The method of claim 1 further comprising the step of creating a text log of at least a portion of the conversation words.

8. The method of claim 7 further comprising the step of performing a keyword search of the text log to determine whether the conversation is of interest to the correctional facility.

9. The method of claim 1 further comprising the step of alerting at least one of the caller and the recipient that the conversation delivered over the communicative connection may be recorded.

10. The method of claim 1, wherein the speech recognition software is executed after the communicative connection has been terminated.

11. A telephone call managing method comprising the steps of:
(a) providing a communicative connection between a caller and a recipient;
(b) providing a database of attorney phone numbers;
(c) delivering a conversation between the caller and the recipient over the communicative connection;
(d) recording at least a portion of the conversation unless the telephone number of the recipient matches a number in the database of attorney phone numbers;
(e) storing the recorded conversation into a call record memory;
(f) executing a speech recognition software to identify a plurality of conversation words within the call record memory;
(g) comparing the conversation words with a database of trigger words; and
(h) flagging the conversation as being of interest based on the comparing step.

12. The method of claim 11 further comprising the step of executing a detection response if the conversation has been flagged.

13. The method of claim 12, wherein the detection response comprises notifying a correctional facility that the conversation has been flagged.

14. The method of claim 12, wherein the detection response comprises blocking a future communicative connection from being provided between the caller and the recipient.

15. The method of claim 12, wherein the detection response comprises routing the conversation to a live operator when a future communicative connection is provided between the caller and the recipient.

16. The method of claim 11, wherein the caller is inside a correctional facility.

17. The method of claim 11, wherein the conversation between the caller and the recipient is delivered over the communicative connection via voice over internet protocol.

18. The method of claim 11 further comprising the step of creating a text log of at least a portion of the conversation words.

19. The method of claim 18 further comprising the step of performing a keyword search of the text log to determine whether the conversation is of interest to the correctional facility.

20. The method of claim 11 further comprising the step of alerting at least one of the caller and the recipient that the conversation delivered over the communicative connection may be recorded.

21. The method of claim 11, wherein the speech recognition software is executed after the communicative connection has been terminated.

22. A system for managing telephone activity within a correctional facility, the system comprising:
a communicative connection between a caller and a recipient constructed and arranged to deliver a conversation between the caller and the recipient; and
a control and monitor system constructed and arranged to receive the conversation, the control and monitor system comprising:
a first database of trigger terms;
a memory constructed and arranged to store the conversation delivered over the communicative connection into a call record;
a speech recognition module constructed and arranged to identify a plurality of conversation words within the call record, the speech recognition module is further constructed and arranged to compare the conversation words with the database of trigger terms to determine whether the conversation is of interest to the correctional facility.

23. The system of claim 22, wherein the control and monitoring system is constructed and arranged to create a text log of at least a portion of the conversation words, the text log is stored in the memory.

24. The system of claim 22 further comprising a correctional facility computer in communicative connection with the control and monitoring system, wherein the correctional facility computer is constructed and arranged to access the memory and perform a keyword search of the text log to determine whether the conversation is of interest to the correctional facility.

25. The system of claim 22, wherein the control and monitoring system further comprises a controller constructed and arranged to execute a detection response when the control and monitoring system determines that the conversation is of interest to the correctional facility.

26. The system of claim 25, wherein the detection response comprises notifying the correctional facility that the conversation has been flagged as being of interest to the correctional facility.

27. The system of claim 26, wherein the detection response comprises blocking a future communicative connection from being provided between the caller and the recipient.

28. The system of claim 25, wherein the detection response comprises routing the conversation to a live operator when a future communicative connection is provided between the caller and the recipient.

29. The system of claim 22, wherein the communicative connection is constructed and arranged to deliver communications between caller and the recipient via voice over internet protocol (VoIP).

30. The system of claim 29, wherein the caller is inside the correctional facility.

31. The system of claim 22, wherein the control and monitoring system is constructed and arranged to alert at least one of the caller and the recipient that the conversation delivered over the communicative connection may be recorded.
